(19) United States
(12) Patent Application Publication
(10) Pub. No.: US 2017/0136398 A1
(43) Pub. Date: May 18, 2017

(54) DEVICE AND METHOD FOR ABSORBING ORGANIC CONSTITUENTS IN AMBIENT AIR

(71) Applicant: KONINKLIJKE PHILIPS N.V., EINDHOVEN (NL)

(72) Inventors: XINZHONG LAI, EINDHOVEN (NL); WEIMIN XIAO, EINDHOVEN (NL); YANLING GAO, EINDHOVEN (NL); YI XU, EINDHOVEN (NL)

(21) Appl. No.: 15/319,873

(22) PCT Filed: Jun. 26, 2015
(86) PCT No.: PCT/EP2015/064476

§ 371 Date: Dec. 19, 2016

(30) Foreign Application Priority Data
Jun. 27, 2014 (CN) PCT/CN2014/081050
Jul. 30, 2014 (EP) 14179071.7

(51) Int. Cl. B01D 47/02; F24C 15/20

(52) U.S. Cl. CPC B01D 47/021; F24C 15/2057

(57) ABSTRACT

The invention relates to a device for absorbing organic constituents in ambient air formed by a cooking appliance. The device comprises a first reservoir (10) containing a first liquid (12) comprising a lipophilic solution. The first reservoir comprises an air inlet (14) and an air outlet (16), the outlet communicating with a space (18) over the liquid. The device also comprises a system (20) for pumping the ambient air to the first reservoir through the inlet. The device also comprises a first system (24,26) to bubble the pumped ambient air in the first liquid (12), to generate an output air stream exiting the first reservoir via the outlet (16). The lipophilic solution (12) comprises a plant oil. This invention provides a low cost and safe air filtering device which is effective in removing organic matter such as cooking fumes.

### FIELD OF THE INVENTION

This invention relates to the absorption of organic constituents in ambient air, such as may be formed by cooking.

### BACKGROUND OF THE INVENTION

Cooking plays a fundamental role in daily life across the globe. While cooking makes food safe and enjoyable for human consumption, the cooking process often involves heating food in cooking oil. The indoor air quality is often greatly impacted by the cooking process.

A large amount of cooking oil fume (COF) can be generated during cooking, especially in frying and roasting. Cooking oil fume is one of the major sources of particulate matter indoors. It can create stubborn grease on the surface areas around the kitchen which is of concern for hygiene, odor, and safety reasons. A grease coating creates a slippery surface as well as being flammable in nature.

Also, COF has adverse health effects due to the presence of certain compounds, including polycyclic aromatic hydrocarbons (PAHs), heterocyclic aromatic amines, and unsaturated aldehydes.

Moreover, studies have also reported that cooking oil fume is a significant source of general atmospheric particulate organic matter.

Currently, cooking oil fume is either released freely into the air or is extracted by a cooker hood and then discharged to the outdoor atmosphere. This causes severe pollution for both the indoor and the outdoor environment. Of course, discharging the pollution to the outdoor environment does at least reduce the concentration to which the user is exposed, so that a cooker hood does provide health benefits. A cooker hood is of course not portable. Due to the large size of the cooker hood and its accessories for discharging to the outdoor atmosphere, it is typically only purchased as part of a kitchen assembly and it takes up a significant space.

US2005/145108 describes a system for cleaning air wherein the air to be cleaned is bubbled up through an aqueous phase and an organic phase. The air is bubbled upwardly through the liquid. The organic phase is generally on top of the aqueous phase. It is describes that gases are removed either continuously or periodically to ensure that there are adequate reagents in the aqueous and organic phases, so that the reagents therein can be replaced as needed. It is described that there is no limit to the number of cylinders that can be used, depending upon the impurity and thus the amount of reagents to be used in treating the air.

GB2258623 describes a waste gas purifying device employing an intermediate exhaust fan and a pump to suck the waste gas flowing through a chimney into at least one washing tank. The washing tank contains a washing liquid which can remove the particles or toxic gas in the waste gas, the purified gas being then discharged back to the chimney via line. More than one washing tank may be used. Bubble breaker is provided adjacent to the end of the gas inlet pipe in tank to produce fine bubbles and hence better contact.

WO97/48475 describes a fluid extraction apparatus comprising a passage having an upstream end, a downstream end and a cross-sectional flow area for the pumped flow therealong of a first fluid in a downstream direction. The apparatus further comprises a fluid flow area control device having an upstream side and a downstream side and providing at said downstream side an increase in the available cross-sectional flow area of said passage between said upstream and downstream ends. The apparatus further comprises an inlet to said passage at or downstream of said downstream side of said device, whereby pumped flow of the first fluid along said passage past said device reduces the fluid pressure at said inlet to cause a second fluid to be drawn into said passage via said inlet to flow with the first fluid towards said downstream end.

### SUMMARY OF THE INVENTION

It is an object of the present invention to propose an improved device and method for absorbing organic constituents in ambient air formed by a cooking appliance.

This object is solved by the subject-matter of the independent claims, wherein further embodiments are incorporated in the dependent claims.

To this end, the device according to the invention comprises:
a first reservoir containing a first liquid comprising a lipophilic solution, said first reservoir comprising an air inlet and an air outlet, the outlet communicating with a space over said liquid;
a system for pumping said ambient air to the first reservoir through said inlet; and
a first system to bubble the pumped ambient air in said first liquid, to generate an output air stream exiting said first reservoir via said outlet, wherein the lipophilic solution comprises a plant oil.

This device passes the air through a lipophilic solution in order to remove organic particles. These organic particles can be caused by cooking, and the air being processed typically includes cooking fumes. This provides an effective and low cost filtering operation. In particular, ordinary household products or ingredients can be used to form the lipophilic solution. By passing the air through the lipophilic solution (at room temperature for example), it has been found that very efficient removal of oil-based particulates in the cooking fumes can be achieved.

This air treatment device can remove potentially harmful organic compounds from the air in a cost effective and user-friendly way, which makes it suitable for a use by consumers in the home. This device can be made portable, and can be implemented simply in a kitchen without requiring a kitchen redesign.

Because the lipophilic solution comprises a plant oil, the filter can be implemented using a readily available product to form the lipophilic solution, and the solution can be replaced by a user when needed. When a plant oil is used, it may comprise soy bean oil, sunflower oil, ground nut oil, corn oil, coconut oil or olive oil for example. It may comprise the same oil as is used by a cooking device associated with the absorbing device. This means the absorbing device can be cleaned and replenished using the same oil as used for cooking, simplifying maintenance of the absorbing device.

The first system to bubble may comprise a delivery pipe connected to the inlet, said delivery pipe comprising an array of openings for releasing the pumped ambient air into different regions of the liquid in said first reservoir.

This delivery pipe causes the fumes to be dispersed within the absorbing liquid to improve the efficiency of the absorption process.

The first reservoir may contain a second liquid comprising a hydrophilic solution, wherein said first liquid and said second liquid are immiscible, and wherein said first system to bubble the pumped ambient air in said first liquid is also adapted to bubble the pumped ambient air in said second liquid.

In this way, the lipophilic liquid floats on the hydrophilic liquid and two different absorption processes can be carried out within the single reservoir.

The second liquid may comprise water or an aqueous solution. The aqueous solution may comprise a salt solution. This can be used to make the two liquids more immiscible.

In alternative implementation, the device further comprises:
a second reservoir containing a second liquid comprising a hydrophilic solution, said second reservoir comprising an air inlet and an air outlet, the outlet communicating with a space over said second liquid, and
a second system to bubble the air in said second liquid, to generate an output air stream exiting at the outlet of said second reservoir, wherein:

the reservoirs are arranged in a sequence of the first reservoir then the second reservoir with the outlet of the first reservoir connected to the inlet of the second reservoir, or

the reservoirs are arranged in a sequence of the second reservoir then the first reservoir with the outlet of the second reservoir connected to the inlet of the first reservoir.

This arrangement provides two separate reservoirs in series, to provide two different absorption processes. They can be in either order.

The second system to bubble may also comprise a second delivery pipe connected to the air inlet of the second reservoir and which also comprises an array of openings for releasing the air into different regions of the second liquid in the second reservoir.

In one arrangement the outlet of the second reservoir is connected to the inlet of the first reservoir.

This arrangement provides removal of the water content first (by the second reservoir), and this may make the subsequent removal of the organic components (by the first reservoir) more effective. The second liquid may again comprise water or an aqueous solution.

An embodiment of the invention also provides a cooking appliance, comprising:

a heating element:

an air collector positioned over the heating element; and

a device of the invention for collecting and processing ambient air from the air collector.

In this way, the air treatment arrangement can be formed as an integrated part of a cooking appliance. This gives the user freedom to choose cooking anywhere, inside or outside the house, without worrying about cooking oil fumes.

An arrangement may be provided for adjusting the position of the air collector over the heating element. This enables the collection of fumes to be optimized to give the greatest reduction in fumes.

According to another embodiment of the invention, there is provided a method of absorbing organic constituents in ambient air, said method comprising the steps of:
pumping ambient air to a reservoir containing a liquid comprising a lipophilic solution wherein the lipophilic solution comprises a plant oil;
bubbling the pumped ambient air in said liquid; and
providing an output air stream exiting from said liquid.

The ambient air may also be bubbled in a liquid comprising a hydrophilic solution.

### BRIEF DESCRIPTION OF THE DRAWINGS

Examples of the invention will now be described in detail with reference to the accompanying drawings, in which:

FIG. 1 shows a first example of an air treatment device in accordance with an embodiment of the invention;

FIG. 2 shows a second example of an air treatment device in accordance with an embodiment of the invention:

FIG. 3 shows a third example of an air treatment device in accordance with an embodiment of the invention;

FIG. 4 shows a fourth example of an air treatment device in accordance with an embodiment of the invention;

FIG. 5 illustrates the flow chart of a method of absorbing organic constituents in ambient air according to the invention.

### DETAILED DESCRIPTION OF EMBODIMENTS

The invention provides a device for absorbing organic constituents in ambient air, in which a reservoir contains a lipophilic solution through which ambient air is bubbled to remove organic constituents of the ambient air. This provides a low cost and safe air filtering device which is effective in removing organic matter such as cooking oil fumes.

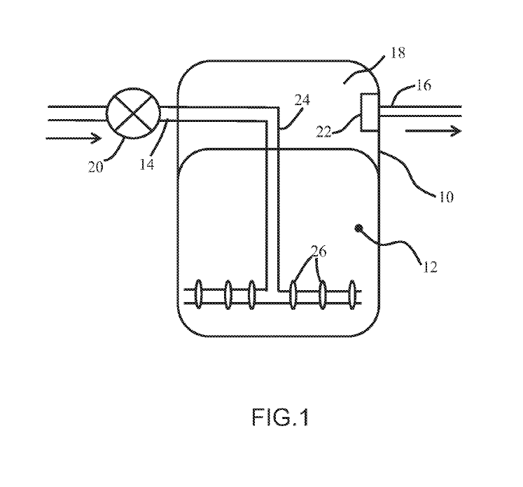

FIG. 1 shows a first example of an air treatment device, which is most suitably used for treating ambient air in the vicinity of a cooking device, in particular to remove cooking oil fumes, which contain organic constituents.

The device has a reservoir 10 containing a liquid 12 comprising a lipophilic solution. The reservoir 10 has an air inlet 14 and an air outlet 16, the outlet communicating with a space 18 over the liquid.

The device comprises a system 20, for example a pump, for pumping the air to be treated to the reservoir 10 through the inlet 14. The pump may for example be a vacuum pump, a diaphragm pump or a peristaltic pump. The air is made to bubble through the liquid 12, and then escapes as an output air stream exiting the reservoir 10 via the outlet 16.

Arrangement (24, 26) forms a first system to bubble the pumped ambient air in the first liquid 12, to generate an output air stream exiting the first reservoir via the outlet 16. A solid or mesh filter 22 may optionally be provided at the outlet as shown.

This device passes the air through a lipophilic solution in order to remove organic particles. This provides an effective and low cost filtering operation. In particular, ordinary household products or ingredients can be used to form the solution. Examples are plant oil or paraffin.

By passing the air through the lipophilic solution (at room temperature for example), it has been found that very efficient removal of oil-based particulates in the cooking fumes can be achieved.

Various plant oils or paraffin are widely available as non-hazardous low cost supplies which can be bought by consumers. This means the device can be serviced (e.g. the oil changed) easily and safely by a consumer. The plant oil may comprise soy bean oil, sunflower oil, ground nut oil, corn oil, coconut oil or olive oil for example.

The air treatment device may be a portable unit used with a particular cooker, such as a deep fat fryer. In this way, it can use the same oil in its reservoir as is used by the cooking device. This means the absorbing device can be cleaned and replenished using the same oil as used for cooking, simplifying maintenance of the air treatment device.

The inlet 14 connects to a delivery pipe 24 which passes to the bottom of the reservoir. It has an array of openings 26 for releasing the pumped ambient air into different regions of the liquid. This delivery causes the fumes to be dispersed within the absorbing liquid to improve the efficiency of the absorption process.

The device of FIG. 1 has a single reservoir for removal of organic particles in the air stream. It is possible to use multiple similar devices in series, each designed for removing a particular class of pollutants.

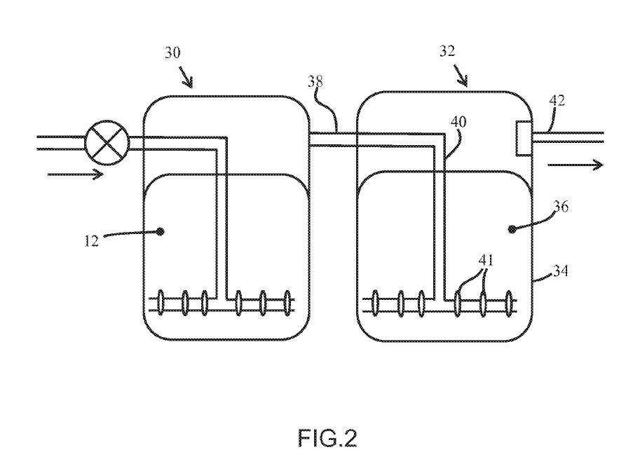

FIG. 2 shows an implementation with two air treatment devices. The device 30 is the same as in FIG. 1 (but without the outlet filter 22). It connects to a second device 32 of similar design. Thus, the second device 32 has a second reservoir 34 containing a second liquid 36. An air inlet 38 couples to a second system 40 to bubble the air in the second liquid 36. An output air stream exits at the outlet 42 of the second reservoir. The air outlet 42 communicates with a space over the second liquid 36.

The reservoir 30 with the lipophilic solution can be at the inlet side or the exit side, so that the two reservoirs can be arranged in either order. FIG. 2 shows the outlet of the first reservoir 30 connected to the inlet 38 of the second reservoir 34.

The liquid in the second reservoir comprises a hydrophilic solution. This acts as an absorber for water vapor. It can comprise water or an aqueous solution.

The second system 40 to bubble again comprises a delivery pipe 40 with an array of openings 41 for releasing the air into different regions of the second liquid in the second reservoir.

If the water vapor is removed first (i.e. the opposite order to that shown in FIG. 2) this may make the removal of the organic components more effective.

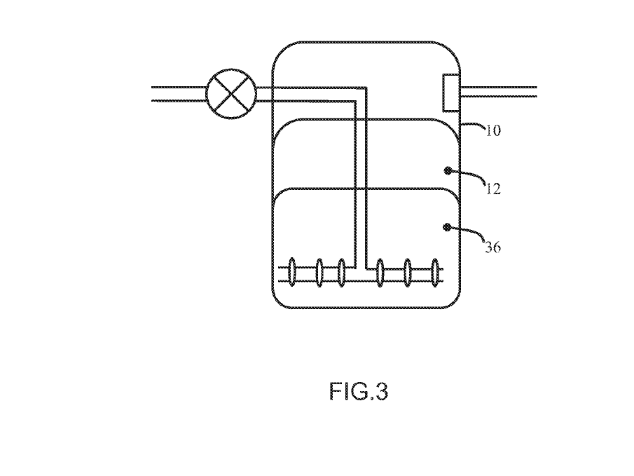

The use of two different absorbing liquids may be combined into a device with a single reservoir as shown in FIG. 3.

FIG. 3 shows a device of the same design as FIG. 1 but containing the lipophilic solution 12 floating on the hydrophilic solution 36 within the same reservoir 10.

The hydrophilic solution and the lipophilic solution are immiscible, and the pumped air is bubbled through both liquids. The second liquid may be selected for improved separation between the two liquids, by making them more immiscible. A salt solution may be used as the hydrophilic solution 36 for this purpose.

The air treatment approach explained above may be integrated into a cooking device. For example it may be used as part of a portable cooking device such as a fryer (which cannot make use of a fixed cooker hood if the cooker is also in use) or a cooker.

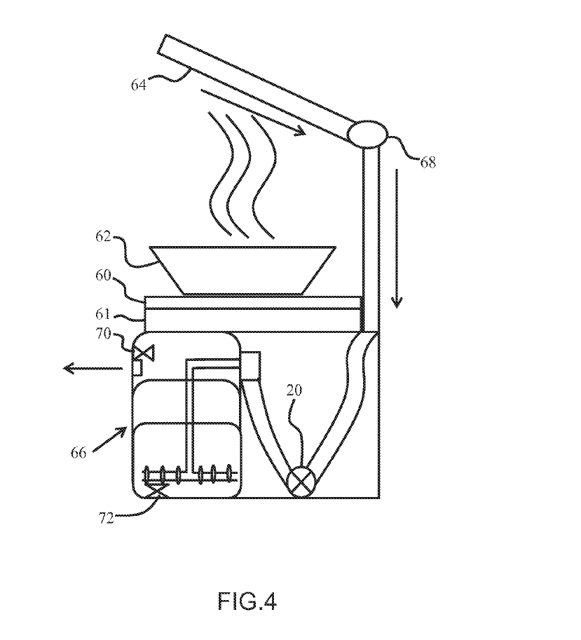

FIG. 4 shows an example based on the double-liquid air treatment approach of FIG. 3.

The cooking device of FIG. 4 has a heating element which in this example comprises an electric hot plate 60 on which a cooking pan 62 can be placed. An air collector 64 is positioned over the heating element 60. The air collector feeds air to the air treatment device 66 which is of the type shown in FIG. 3. Of course it may instead be of the type shown in FIG. 1 or 2.

The hot plate is insulated from the remainder of the device by layer 61.

The pump 20 is housed within the cooking device and draws air from the air collector.

The user can make use of the cooking device anywhere, inside or outside the house, without worrying about cooking oil fumes.

The air collector can have an adjustable position, for example with hinge arrangement 68 so that the collection of fumes can be optimized to give the greatest reduction in fumes.

The treatment device has a filling port 70 and emptying port 72 so that a user can maintain the device by changing the liquid or liquids periodically. These ports are not shown in FIGS. 1 to 3 but those reservoirs can of course also be filled and emptied likewise.

The device can be used for air treatment in respect of another cooking device, with the hot plate not in use. Thus, it may be used as a portable air treatment device or a cooking device with integrated air treatment for reducing the cooking oil fume concentration.

The various alternative devices all function in the same way. Ambient air is pumped to a reservoir containing a liquid which at least includes a lipophilic solution. The pumped ambient air is bubbled in the liquid before being expelled in a purified form.

The device can be used as a standalone air treatment unit, which may be a fixed part of an installation or it may be portable. It may also be formed as an integrated part of a fixed or a portable cooking device. This cooking device may include, but not limited to, a fryer, hob, toaster, steamer or any other type of cooking device which will potentially provide pollution.

The reservoir can have a size chosen to match the type of cooking device either for domestic or commercial kitchens. For example, it may have a volume of 0.3 Liters to 1.5 Liters for domestic kitchen. A volume of oil in the range 0.2 Liters to 1 Liter may be used as the lipophilic solution and a volume of water in the range 0.2 Liters to 1 Liter may be used as the hydrophilic solution.

The pump can deliver a flow rate to the reservoir which can be adjusted by the user, for example with different fan speeds to meet the need of either domestic or commercial kitchens. The air flow rate will typically be in the range 0.2 Liters per minute to 5 Liters per minute for domestic application and maybe higher for commercial kitchens.

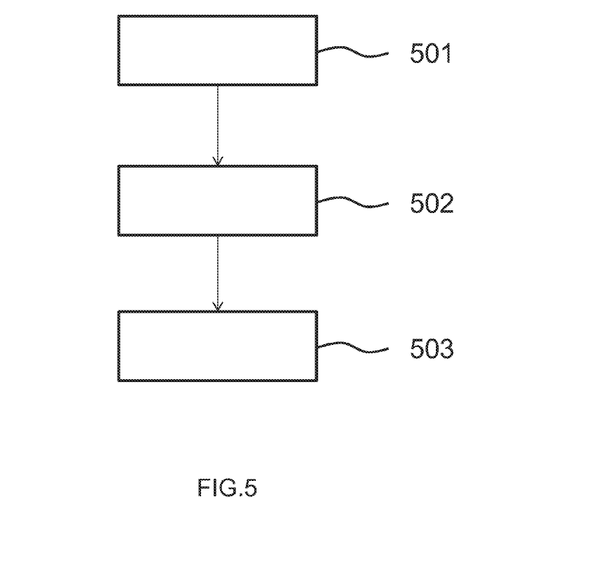

FIG. 5 illustrates the flow chart of a corresponding method of absorbing organic constituents in ambient air according to the invention. The method comprises the steps of:
pumping (501) ambient air to a reservoir containing a liquid comprising a lipophilic solution;
bubbling (502) the pumped ambient air in said liquid; and
providing (503) an output air stream exiting from said liquid.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A cooking appliance comprising:
a heating element to cook food;
an air collector positioned over the heating element to collect organic constituent laden air; and
a device for absorbing the organic constituents in the air collected by the air collector, said device comprising:
a first reservoir containing a first liquid comprising a lipophilic solution, said first reservoir comprising an air inlet and an air outlet, the outlet communicating with a space over said liquid;
a system for pumping said ambient air to the first reservoir through said inlet; and
a first system to bubble the pumped ambient air in said first liquid, to generate an output air stream exiting said first reservoir via said outlet;
wherein the lipophilic solution comprises a plant oil.

2. A cooking appliance as claimed in claim 1, wherein said first system to bubble comprises a delivery pipe connected to the inlet, said delivery pipe comprising an array of openings for releasing the pumped ambient air into different regions of the liquid in said first reservoir.

3. A cooking appliance as claimed in claim 1, wherein the first reservoir contains a second liquid comprising a hydrophilic solution, wherein said first liquid and said second liquid are immiscible, and wherein said first system to bubble the pumped ambient air in said first liquid is also adapted to bubble the pumped ambient air in said second liquid.

4. A cooking appliance as claimed in claim 3, wherein the second liquid comprises water or an aqueous solution.

5. A cooking appliance as claimed in claim 4, wherein the aqueous solution comprises a salt solution.

6. A cooking appliance as claimed in claim 1, further comprising:
a second reservoir containing a second liquid comprising a hydrophilic solution, said second reservoir comprising an air inlet and an air outlet, the outlet communicating with a space over said second liquid, and
a second system to bubble the air in said second liquid, to generate an output air stream exiting at the outlet of said second reservoir, wherein:
the reservoirs are arranged in a sequence of the first reservoir then the second reservoir with the outlet of the first reservoir connected to the inlet of the second reservoir, or
the reservoirs are arranged in a sequence of the second reservoir then the first reservoir with the outlet of the second reservoir connected to the inlet of the first reservoir.

7. A cooking appliance as claimed in claim 6, wherein said second system to bubble comprises a second delivery pipe connected to the air inlet of the second reservoir which comprises an array of openings for releasing the air into different regions of the second liquid in the second reservoir.

8. A cooking appliance as claimed in claim 6, wherein the outlet of the second reservoir is connected to the inlet of the first reservoir.

9. A cooking appliance as claimed in claim 6, wherein the second liquid comprises water or an aqueous solution.

10. (canceled)

11. A cooking appliance as claimed in claim 1, comprising an arrangement for adjusting the position of the air collector over the heating element.

12. (canceled)

13. (canceled)
